(19) United States
(12) Patent Application Publication
(10) Pub. No.: US 2013/0064930 A1
(43) Pub. Date: Mar. 14, 2013

(54) MULTILAYER FOOD PRODUCT AND METHOD FOR PREPARING SAME

(71) Applicant: NESTEC S.A., Vevey (CH)

(72) Inventors: Jean-Jacques Moreau, Manerbe (FR); Marion Hofmann, Radolfzell (DE); Jean-Emmanuel Serre, Le Mesnil-Eudes (FR)

(73) Assignee: NESTEC S.A., Vevey (CH)

(21) Appl. No.: 13/645,350

(22) Filed: Oct. 4, 2012

Related U.S. Application Data
(63) Continuation of application No. 11/996,934, filed on Jul. 21, 2008, now abandoned.

(30) Foreign Application Priority Data
Jul. 28, 2005 (FR) 0508077

(51) Int. Cl. A23P 1/08; B65B 1/04

(52) U.S. Cl. CPC A23P 1/085; B65B 1/04
USPC 426/89; 426/305; 426/291; 53/474

(57) ABSTRACT

The invention concerns a multilayer food product and a method for obtaining a multilayer food product which includes at least one lower layer and one upper layer of thermally stable food components, wherein the lower layer has a low viscosity and the upper layer has a uniform distribution.

### BACKGROUND

The invention relates to a process for obtaining a multilayer food product, in particular a multilayer dessert, comprising at least one lower layer and one upper layer (or surface layer), the said lower layer having a low viscosity, each layer being based on heat-stable food components, in which the upper layer (or surface layer) has a uniform distribution, in particular when the said upper layer (or surface layer, is composed of fat or of food matter with a density greater than that of the lower layer.

The invention also relates in particular to a multilayer food product comprising at least one lower layer and one upper layer (or surface layer) based on heat-stable food components, in which the said lower layer has a low viscosity, and in particular a product of this kind in which the upper layer (or surface layer) is composed of fat.

In the description hereinbelow, the upper layer will preferably be referred to as a “surface layer” when the multilayer food product comprises only two layers, i.e. a layer of product to be covered and a coating layer.

The term “lower layer” means the layer of product to be covered or of food component to be covered that is immediately below the upper layer (or surface layer), independently of the fact that the final multilayer food product may comprise a plurality of lower layers and of surface layers.

The term “multilayer food product” means a food product comprising at least one lower layer and one upper layer as defined above, the lower layer possibly comprising, in a non-limiting manner, any heat-stable food component, especially based on milk (fermented or unfermented, whipped or unwhipped), fruit, cereals, egg, etc.

The expression “low-viscosity lower layer” means that, during the metering of the food matter constituting the upper layer, the lower layer is not solid, i.e. it is not self-supporting, and is liable to spread or run if it is not contained in a container.

The said lower layer may thus have a fluid consistency.

In particular, the said lower layer may have a viscosity of about from 3000 to 25 000 mPa·s and preferably from about 8000 to 20 000 mPa·s.

The viscosity may be measured using a Brookfield RVDV II+ viscometer, using a No. 93 spindle, with a spin speed of 5 rpm, at a temperature of 15° C.

Preferably, the measurement is taken in the container containing the said lower layer, after about one revolution of the unit, for example after 10 seconds.

Alternatively, the said lower layer may have a Bostwick consistency of greater than 8 cm. The Bostwick consistency is defined by the measurement of the path of flow of a product on an inclined plane at 20° C. for 120 seconds. A machine sold by CSC Scientific Company Inc. (USA) or Kinematica AG (CH) may be used, for example, to take this measurement.

Among the known processes for obtaining multilayer desserts, processes of pressurized spraying type are widely used. However, due to the energy supplied to the drops of fat resulting from the use of pressure, the drops strike the surface of the product, which they may damage, and the fat is especially distributed at the periphery, resulting in potential fragility of this layer at the centre of the pot, during transportation and handling.

A process of this type is described in patent application EP-A-770 332.

Moreover, during this striking, the drops of fat may trap air microbubbles, which is liable to give the layer of fat, especially when it is chocolate, an undesired matt appearance.

Processes of nebulization type are also known, such as that described in patent application DE 2 239 986, which are used, for example, for covering hard surfaces such as cakes: in this case, the fat is conveyed by compressed air a short distance onto the surface to be covered, which prohibits its use on a soft surface.

Glazing processes, such as the glazing of cakes with a sugar-based layer, i.e. the covering of a solid lower layer, are also known in the food sector. In such processes, the covering may be performed by spreading the glazing matter over the solid lower layer and/or by expulsion under pressure of the glazing matter.

The technical problem to be solved thus consists in obtaining a multilayer food product in which the upper layer (or surface layer) has a uniform distribution and a satisfactory appearance for the consumer, in particular when the lower layer and the upper layer are incompatible with respect to the spreading of the upper layer, that is to say that the spreading cannot take place naturally simply by depositing the upper layer on the lower layer.

Such a case arises, for example, when the lower layer is hydrophilic and the upper layer is hydrophobic, because of the hydrophilic/hydrophobic pressures which prevent spreading, and/or when the lower layer has a low viscosity insofar as the spreading cannot be forced without causing the upper layer to penetrate into the lower layer.

### SUMMARY OF THE INVENTION

It has now been found that by depositing the food matter constituting the upper layer (or surface layer? without supplying pressure and without using compressed air, and by applying, to the lower layer, a force which allows the upper layer to spread, which force offsets this incompatibility, it was possible to obtain an upper layer made of a uniform food matter which is continuous, in particular in the case where the lower layer has a low viscosity.

According to the process of the invention, the food matter constituting the upper layer (or surface layer) is subjected to release controlled mechanically by multiple orifices, whereas the pot containing the product to be covered is subjected to a centrifugal and/or alternative force.

The term “alternative force” means that the container is subjected to an alternative movement, for example, a lateral shift.

According to one preferred aspect, the food matter constituting the upper layer (or surface layer) is a fat.

In this case, the process according to the invention advantageously allows, despite the hydrophobic nature of the drops of fat, and the possibly hydrophilic nature of the surface onto which they are deposited, a uniform deposition as a thin, continuous layer, without damaging the structure of the surface of the product to be covered.

Furthermore, the process according to the invention allows the production of a multilayer food product in which the upper layer (or surface layer) is uniformly distributed.

Advantageously, the said upper layer (or surface layer) shows better impact strength due to this uniform distribution than the products obtained via the prior-art processes and a more aesthetic appearance (no projections onto the edges of the pot), while at the same time conserving ease of breaking with a spoon. This resistance to breaking is also quantifiable by texture analysis and a breaking test (measurement with a TAXT2 Texture Analyser from the company Stable Micro Systems, cylinder 4 mm in diameter SMS P/4, speed 0.5 mm/s, depth 2 mm). It is preferably greater than or equal to 200 g.

### BRIEF DESCRIPTION OF THE DRAWING FIGURES

FIG. 1 is a schematic representation of a device for metering food matter according to the invention; and

FIG. 2 is a schematic representation of a system for implementing the process according to the invention.

### DETAILED DESCRIPTION OF THE INVENTION

The term “uniform distribution” means that, after deposition, the upper layer (or surface layer) has substantially the same thickness at any point of its surface.

The said process is particularly suitable in the case of acidic or fermented dairy products with a low viscosity and for which it is difficult to deposit a surface layer without damaging the surface of the lower layer.

The expression “acidic or fermented dairy product” means a product based on fermented milk or acidified milk, having an acidic or neutral pH, for instance a fromage blanc, a fermented product containing live ferments, such as a yogurt or a specialty product based on fermented milk. The acidification may be performed, for example, using lactic acid, citric acid or phosphoric acid. The ferments may be chosen, for example, from Lactobacillus casei, Lactobacillus bulgaricus, Lactobacillus acidophilus, Streptococcus thermophiles, bifidus, etc.

The process according to the invention involves a combination of metering means, distribution means and means for positioning the container containing the product to be covered.

Preferably, the process according to the invention comprises the steps consisting in:
metering out the food matter constituting the upper layer (or surface layer),
distributing the said matter using a rotary mechanical bushel through a plate having a plurality of orifices onto the surface of a product to be covered constituting at least one lower layer contained beforehand in a container, and
simultaneously, subjecting the said container to a centrifugal or alternative force.

Preferential conditions of the process may be chosen from the following:
at least one lower layer is hydrophilic and at least one upper layer is hydrophobic;
the food matter constituting the upper layer (or surface layer) is a fat;
the metering of the food matter constituting the upper layer (or surface layer) may be performed using a metering piston;
the thrust of the metering piston is controlled so as not to give the drops to be deposited any kinetic energy. Preferably, a thrust will be exerted that allows the release of the food matter constituting the upper layer (or surface layer) solely by the effect of the force of gravity on the said food matter:
the metering of the food matter constituting the upper layer (or surface layer), when it has a high viscosity (up to 30 000 mPa·s), may be performed using a positive-displacement pump;
the force applied to the container is preferably adjusted to cause the displacement of the drops of food matter constituting the upper layer (or surface layer), and not that of the product to be covered constituting at least one lower layer contained in the container; in particular, a centrifugal force may be exerted by rotating the pot at about 1 to 5 s⁻¹ and especially about 1 to 3.5 for fluid products, and about 3 to 5 s⁻¹ for more viscous products;
the temperature during the release of the food matter constituting the upper layer (or surface layer) is adjusted so as to keep the food matter in the liquid phase, for example from about 30 to 75° C. and preferentially 60 to 70° C.

The term “rotary mechanical flow regulator”, also known as a rotating flap valve, means a machined mechanical component, preferably with a flat surface, which, under the action of rotation, gradually exposes, in a controlled manner, all the distribution orifices located on the plate bearing the said orifices (nozzle plate). The dose released by each orifice is, by this means, substantially the same.

Advantageously, the process according to the invention also makes it possible to solve the problem of clogging of the nozzle, which is often encountered during the use of pressurized spraying processes.

Specifically, the orifices of the nozzle plate used in the process of the invention may be from about 0.5 to 4 mm in diameter, which allows the inclusion of particles into the food matter constituting the upper layer (or surface layer).

Due to the wide possibilities for adapting the process according to the invention, there is no particular limit to be observed as regards the choice of food matter constituting the upper layer (or surface layer).

According to one aspect of the process according to the invention, the final product comprises a single lower layer of food component to be covered, and a single upper layer (or surface layer) of food matter.

Alternatively, the invention also relates to the production of a multilayer food product comprising an alternation of lower layer and of upper layer (or surface layer), the said upper layer (or surface layer) itself possibly consisting of several layers.

The said food matter should be able to be heat-treated in order to comply with the regulations in force, and in particular should be able to be sterilized or pasteurized.

Non-limiting examples that may be mentioned include fats or mixtures of fats chosen from chocolate, vegetable fats of the type such as cocoa butter or the like, for instance hardened copra fat, or chocolate-based compounds.

The term “chocolate” means a mixture of cocoa butter, cocoa powder or cocoa liquor, sugar, and flavourings, with a content of cocoa butter of from 50% to 90% in weight of the mixture.

Chocolate-based compounds may also be used, which comprise, for example, a mixture of cocoa butter or of another vegetable fat, for instance hardened copra fat, cocoa powder or cocoa liquor, water, natural or artificial flavourings, for instance vanilla, and sweeteners, with a content of cocoa butter or other vegetable fat of from 50% to 100% by weight of the mixture.

The said food matter may also be chosen from sugar syrups (glucose syrup, maple syrup, caramel, etc.), fruit-based products (coulis, marmalade, compote, pure, etc.), milk-based products (thick cream, etc.), alone or as a mixture with one or more food additives, such as thickeners and/or gelling agents and/or texturing agents, for example galactomannans, pectins, alginates, carrageenans, xanthan gum, gelatin and/or starches.

It may also comprise one or more ingredients chosen from natural or artificial colorants and natural or artificial flavourings.

It may also contain solid additives in particulate form, for instance fragments of dry or candied fruit; fragments of walnut, hazelnut, almond or citrus peel; cereals, sweet confectionery vermicelli, etc.

The process according to the invention allows the inclusion of the said particulate solid additives of the food matter constituting the upper layer (or surface layer), in which they may be heat-treated, in particular sterilized. After depositing the said layer, the said particulate solid additives may appear at the surface of the upper layer, without impairing their uniform distribution.

In an alternative of the process, a second layer of food matter may cover the first, the said particulate solid additives then being between the two surface layers.

According to another alternative, the said particulate solid additives may be added to the surface layer after depositing it and before it has totally cooled.

The product to be covered, constituting at least one lower layer, is a food matter that may be heat-treated, without viscosity limitation.

Non-limiting examples that may be mentioned include acidic or felmented dairy products, for instance yogurts or fromage frais, mousses (beaten dairy product), creams (dairy phase containing gelling agents) or a fruit-based product (compote or fruit mousse), cereal-based products (dairy phase containing cereals in meal or grain form), cereal-based fermented products, egg-based products, for instance cream with eggs, or soya-based products.

The said product to be covered may especially have a Bostwick consistency, as defined above, of greater than 8 cm.

Alternatively, it may have a viscosity of the order of from 3000 to 25 000 mPa·s, preferably of the order 8000 to 20 000 mPa·s.

The process according to the invention may advantageously be performed when the product constituting the lower layer and the characteristics of the layer of the food matter constituting the upper layer (or surface layer) to be deposited at the surface are incompatible.

### EXAMPLES

Examples that may be mentioned include the following cases:
the deposition of a layer of fat onto a hydrophilic lower layer, for example a layer of chocolate onto a dessert cream;
the deposition of a layer of food matter constituting the upper layer (or surface layer) of high density onto a lighter recipe, for example a concentrated sugar syrup onto a much more fluid base, or a fruit pure onto stirred yogurt;
the deposition of a semi-solid product extruded through the metering nozzle, for example gelatin in the setting phase or chocolate at 25° C., onto a fluid cream.

When the upper layer is a surface layer, it is also possible to place thereon, as decoration, a mousse or a whipped cream or particles such as fragments of dried or candied fruit; fragments of walnut, hazelnut, almond or citrus peel; cereals or confectionery vermicelli.

The process according to the invention especially allows the deposition of the upper layer (or surface layer) having a given appearance, according to the form of the orifices and of the nozzle, and the manner in which these orifices are opened.

The deposition of an airy layer of a dense product, for instance gelatin vermicelli, or any other form depending on the orifices of the nozzle (flat, broad strips, etc.) may be performed.

According to one advantageous aspect of the invention, the process described above may be used to produce multilayer separations with the aim of limiting the exchanges between two masses.

A first mass of food component consisting, for example, of an acidic component such as a fruit coulis or a beaten dairy phase, such as a whipped cream or a chantilly cream, or alternatively an acidic or fermented dairy product, may thus be separated with a surface layer from a second mass consisting, for example, of another dairy phase, such as a mousse or a cream, the two masses possibly being in the reverse order relative to the surface layer separating them.

In this case, the process is performed, for example, in the following manner: the first mass is metered out, the surface layer is then metered out, and the second mass is then metered out.

The thickness of the upper layer (or surface layer) may be adapted as a function of the desired result, without any technical limitation: it will preferably be between 0.3 mm and 6 mm and in particular between 0.5 and 1.5 mm, so as to keep the layer pleasantly breakable with a spoon when it is a fat-based layer, for instance chocolate or a chocolate-based compound.

The deposition of a thicker upper layer does not present any difficulty and may be obtained via metering techniques that are within the capacity of a person skilled in the art.

According to a further subject, the invention also relates to a multilayer food product, especially a multilayer dessert, which may be obtained via the process described above, comprising at least one lower layer and one upper layer (or surface layer), each layer being based on heat-stable food components. Advantageously, the said upper layer (or surface layer) is uniformly distributed.

The invention relates in particular to a multilayer food product that may be obtained via the process described above, comprising at least one lower layer and one upper layer (or surface layer) based on heat-stable food components, in which the said lower layer has a low viscosity.

The preferred aspects of the process, as described above, also apply to the multilayer food products according to the invention.

In particular, the food matter constituting the said upper layer may be a fat or a mixture of fats, or may be chosen from sugar syrups, fruit-based products, milk-based products, alone or as a mixture with one or more food additives, as defined above.

As indicated above, the food matter constituting the upper layer comprises one or more additional ingredients, especially additives in particulate form, these additives optionally being present between two surface layers.

Advantageously, the thickness of the upper layer (or surface layer) is between 0.3 and 6 mm and preferably between 0.5 and 1.5 mm.

The invention relates in particular to multilayer food products in which at least one lower layer is hydrophilic and at least one upper layer (or surface layer) is hydrophobic, and in which at least one lower layer has a low viscosity.

Among these products, those in which the lower layer consists of an acidic or fermented dairy product, especially a yogurt or a fromage frais, are particularly preferred.

Other preferred multilayer food products are those whose lower layer has a Bostwick consistency of greater than 8 cm or alternatively those whose lower layer has a viscosity of about from 3000 to 25 000 mPa·s and preferably from about 8000 to 20 000 mPa·s.

According to another advantageous aspect, the multilayer food product according to the invention comprises a single lower layer of food component to be covered and a single upper layer of food matter covering the said lower layer.

Alternatively, the said multilayer food product may comprise an alternance of lower layer and upper layer, the said upper layer itself possibly being constituted of several layers.

The invention also relates to a device for implementing the process according to the invention, comprising means for metering the food matter constituting the upper layer (or surface layer) solely by the effect of the force of gravity of the said food matter, distribution means and means for positioning the container containing the product to be covered.

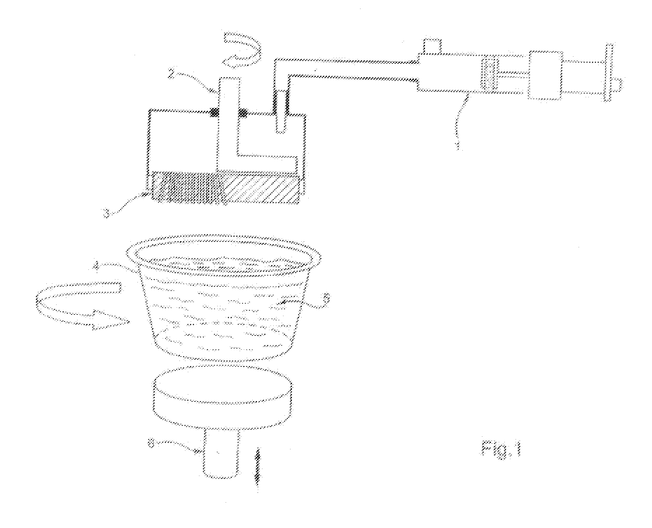

An example of such a device is represented in FIG. 1, which shows a metering piston (1) for pushing the food matter constituting the upper layer (or surface layer) connected to a rotary bushel (2) capable of liberating the multiple orifices of a nozzle plate (3), and a container (4) containing the product to be covered (5), the said container possibly being attached to a rotary raising and lowering system (6) allowing it to be positioned and moved.

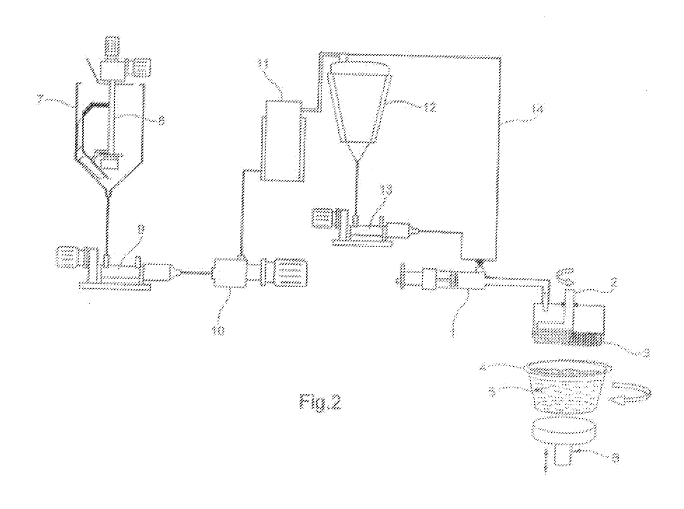

FIG. 2 is a schematic representation of an example of a device for implementing the process according to the invention allowing the production and metering of the upper layer (or surface layer) and the production of a multilayer food product comprising a lower layer of product to be covered and a surface layer: the various constituents of the food matter constituting the surface layer are placed in a tank (7). The mixer (8) provides a homogeneous mix, which is sterilized at high temperature. The pump (9) sends the sterilized mass to a dynamic homogenization system (10), and the product is brought to a temperature below the sterilization temperature by a heat exchanger (11) and then stored in a tank (12) that feeds a pump (13) connected to a metering piston (1) connected to a rotary bushel (2) capable of liberating the multiple orifices of a nozzle plate (3), and a container (4) containing the product to be covered (5), the said container being attached to a rotary raising and lowering system (6). The excess food matter constituting the surface layer is returned via a circuit (14) into the tank (12).

The invention is illustrated in a non-limiting manner by the examples below:

### Example 1

### Preparation of a Vanilla-Flavoured Dessert Cream and of a Chocolate-Flavoured Dessert Cream, Covered with a Layer of Chocolate-Based Food Matter

The multilayer food products whose composition is indicated in Table 1 below were prepared:

TABLE 1

| | Vanilla dessert | Chocolate dessert |
|---|---|---|
| Ingredients | cream (weight %) | cream (weight %) |
| Skimmed milk | 60 to 70 | 60 to 70 |
| Glucose syrup | 0 to 12 | 0 to 12 |
| Cream containing | 1 to 20 | 1 to 20 |
| 30% fat | | |
| Sugar-sucrose | 4 to 12 | 4 to 12 |
| Milk proteins | 0 to 4 | 0 to 4 |
| Modified starch | 1 to 3.5 | 1 to 3.5 |
| E1442 | | |
| Carrageenans | 0_05 to 0.5 | 0.05 to 0.5 |
| Flavouring and | 0.1 to 1.2 | 0 to 0.5 |
| colorant | | |
| Cocoa powder | — | 1 to 3.5 |
| containing 10-12 | | |
| or 20-22% fat | | |
| Chocolate | — | 1 to 6 |
| TOTAL | 100 | 100 |

The process is performed in the following manner:

1—The pulverulent ingredients are premixed and the mixture is then moistened with the warm milk. The cream and the chocolate melted at 38° C. are added and the mixture is subjected to a UHT treatment at 130° C. for a few seconds. After cooling to between 10 and 20° C., the dessert cream is stored in a tank while awaiting metering. Transfer to the metering unit is performed by means of a pumping assembly.

2—For the upper layer, the process is performed in the following manner: the pulverulent ingredients are premixed and added to the cocoa butter and the chocolate melted at 38° C. This mixture is subjected to a sterilizing heat treatment, for example between 110° C. and 120° C. for 8-15 minutes, the treatment being adapted according to the activity of the water. After cooling to between 60 and 70° C., the product is subjected to a homogenization treatment in order to make the product smooth. Storage takes place in a tank while awaiting metering at a temperature of 60-70° C. Transfer to the metering unit takes place by means of a pumping assembly.

3—For the metering: the container is first filled with the dessert cream at a temperature of 10 to 20° C. For example, 90 g of dessert cream are metered into a plastic pot with a total volume of 110 ml and a diameter of 95 mm. Next, the container is brought under the unit for metering out the upper layer, and this container is then raised using a jack to a desired height of the nozzle plate, i.e. 20 to 60 mm.

Metering of the upper layer takes place at the same time as the rotation of the pot so as to promote harmonious spreading of this layer, the force then being from 3 to 5 s⁻¹. The metering temperature of the upper layer is adjustable between 50 and 60° C. to promote flow on the surface of the lower layer. The amount of upper layer deposited is adjusted to 6 to 10 g per pot for a 100 ml pot.

A uniform surface layer 0.5 to 3 mm thick is obtained. At the end of this metering, rotation of the pot is continued until it has descended and passed to the step of sealing with a lid and then packaging and grouping, if necessary. The product is then chilled until a core temperature below 6° C. is obtained.

### Example 2

### Preparation of a Stirred Yogurt Covered with a Layer of Fruit-Based Food Matter

The multilayer food product whose composition is indicated in Table 2 below was prepared:

TABLE 2

| Ingredients | Weight % |
|---|---|
| Skimmed milk | 70 to 80 |
| Cream containing 30% fat | 1 to 12 |
| Sugar-sucrose | 6 to 10 |
| Milk proteins | 1.5 to 4 |
| Yogurt/culture strains | 1 to 3 |
| Flavouring and colorant | gsp |
| Fruit-based preparation | gsp |
| TOTAL | 100 |

The process is performed in the following manner:

1—The pulverulent ingredients are premixed and the mixture is then moistened with the milk. Cream is added, if necessary, and the mixture is subjected to pasteurization at 90-105° C. for a few minutes. After homogenization at a pressure of 50 to 300 bar, the mixture is cooled to a fermentation temperature of about 40° C. and inoculated with the yogurt ferments (Lactobacillus bulgaricus and Streptococcus thermophilus). The mixture is left to ferment in the tank up to a pH of 4.1 to 4.7 and is then stirred and cooled to 10° C. Storage takes place in a tank while awaiting metering. Transfer to the metering unit takes place by means of a pumping assembly.

2—For the upper layer, a pasteurized preparation based on fruit (50-60%), sugars and glucose syrup (20 to 40%) with, depending on the fruit, stabilization based on pectin or xanthan gum, is used. This preparation is stored in a tank or a container, and transfer to the metering unit takes place by means of a pumping assembly.

3—For the metering: the container is first filled with the stirred yogurt at a temperature of 10 to 20° C. For example, 90 g of stirred yogurt are metered into a plastic pot with a total volume of 110 ml. Next, the container is brought under the unit for metering out the upper layer, and this container is raised using a jack to a desired height of the nozzle plate, i.e. 20 to 60 mm. Metering of the upper layer takes place at the same time as the rotation of the pot in order to promote harmonious spreading of this layer, the centrifugal force then being 1 to 3 s⁻¹. The metering temperature of the upper layer is adjusted to between 30 and 40° C. The amount of upper layer deposited is adjusted to 8 to 12 g per pot for a 100 ml pot A uniform surface layer 0.8 to 3 mm thick is obtained. At the end of this metering, rotation of the pot is continued until it has descended and passed to the step of sealing with a lid and then of packaging and grouping, if necessary. The product is then chilled until a core temperature below 6° C. is obtained.

### Example 3

### Preparation of a Vanilla-Flavoured Egg Pudding and a Chocolate-Flavoured Egg Pudding, Covered with a Layer Of Chocolate-Based Food Matter

The multilayer food products whose composition is indicated in Table 3 below were prepared:

TABLE 3

| | Vanilla- | Chocolate- |
|---|---|---|
| | flavoured egg | flavoured egg |
| Ingredients | pudding weight % | pudding weight % |
| Skimmed milk | 35 to 80 | 35 to 80 |
| Glucose syrup | 0 to 12 | 0 to 12 |
| Cream containing 30% | 1 to 35 | 1 to 35 |
| fat | | |
| Sugar-sucrose | 4 to 11 | 4 to 11 |
| milk proteins | 1 to 2 | 1 to 2 |
| Modified starch | 0.5 to 2 | 0.5 to 2 |
| E1442 | | |
| Flavouring and | 0.1 to 0.5 | |
| colorant | | |
| Cocoa powder | | 1 to 3 |
| containing 10-12 or | | |
| 20-22% fat | | |
| Chocolate | | 1 to 6 |
| Eggs | 10 to 15 | 10 to 15 |
| TOTAL | 100 | 100 |

The process is performed in the following manner:

1—The pulverulent ingredients are premixed and the mixture is then moistened with the warm milk. The cream and the chocolate melted at 38° C. are added, and the mixture is subjected to a UHT treatment at 130° C. for a few seconds. After cooling to 50-70° C., the liquid eggs are added, the container is filled and the mixture is baked in an oven for 20-45 minutes at 85-95° C. The pots are stood on a collection belt before metering out the upper layer. The temperature of the product should not be below 70° C.

2—For the upper layer, the process is performed in the following manner: the pulverulent ingredients are premixed and the cocoa butter and the chocolate melted at 38° C. are added. This mixture is subjected to a sterilizing heat treatment at 110° C. for 10 minutes. Before cooling to between 60-70° C., the product is subjected to a homogenization treatment in order to make the product smooth. Storage takes place in a tank while awaiting metering at a temperature of 60-70° C.

Transfer to the metering unit takes place by means of a pumping assembly.

3—For the metering: the container leaving the oven is brought under the unit for metering out the upper layer and this container is raised using a jack to a desired height of the nozzle plate, i.e. 20 to 60 mm. Metering of the upper layer takes place at the same time as the rotation of the pot in order to promote harmonious spreading of this layer, the centrifugal force then being 3 to 5 s⁻¹. The metering temperature of the upper layer is adjusted to between 60 and 75° C. The amount of upper layer deposited is adjusted, for a 100 ml pot, to 6 to 10 g per pot. A uniform surface layer 0.5 to 3 mm thick is obtained. At the end of this metering, rotation of the pot is continued until it has descended and passed to the step of sealing with a lid and then of packaging and grouping, if necessary. The product is then chilled until a core temperature below 6° C. is obtained.

What is claimed is:

1. A process for preparing a multi-layer food product that includes at least one upper layer and at least one lower layer having a lower viscosity than the at least one upper layer, each layer containing heat-stable food components, the process comprising:
metering out food matter making up the at least one upper layer;
distributing the food matter through a plate having a plurality of orifices using a rotary mechanical flow regulator, with the food matter distributed onto a surface of a product to be covered, and with the product constituting the at least one lower layer; and
simultaneously subjecting the lower layer(s) to rotation to apply a centrifugal force to the food matter of the at least one upper layer to provide a uniform deposition of the at least one upper layer in a final product.

2. The process of claim 1, wherein the at least one lower layer is hydrophilic and the at least one upper layer is selected from an upper layer having a fat content and an upper layer that is hydrophobic.

3. The process of claim 1, wherein the at least one lower layer has a viscosity of from about 3000 to 25000 mPa·s and a Bostwick consistency higher than 8, and the food matter making up the at least one upper layer has at least one fat component selected from the group consisting of a chocolate and a vegetable fat.

4. The process of claim 3, wherein the at least one fat component is selected from a chocolate that includes a mixture of cocoa butter and cocoa powder or liquor, and a mixture of a chocolate and vegetable fat, wherein the vegetable fat is present in an amount of at least 50% by weight of the mixture.

5. The process of claim 1, wherein the food matter for the at least one upper layer comprises at least one of sugar syrups, products containing fruits, products containing milk and mixtures thereof, and wherein the food matter may further comprise one or more food additives.

6. The process of claim 1, wherein the at least one upper layer has a thickness of between 0.3 mm and 6 mm, and the food matter making up the at least one upper layer includes one or more ingredients chosen from thickening agents, gelling agents, texturing agents, natural dyes, artificial dyes and natural and artificial flavors.

7. The process of claim 1, wherein the at least one upper layer includes particulate additives selected from the group consisting of dry fruit fragments, crystallized fruit fragments, nut fragments, citrus peels, cereals and confectionery vermicelli.

8. The process of claim 1, wherein the at least one upper layer is prepared by depositing at least one layer of the food matter, applying the particulate additives and then applying at least one additional layer of the food matter.

9. The process of claim 8, wherein the particulate additives are applied onto the food matter of the at least one upper layer after the at least one upper layer has been deposited in the container and before the at least one upper layer has totally cooled.

10. The process of claim 8, wherein the temperature of the food matter during its release to prepare the at least one upper layer is about 30 to 75° C.

11. The process of claim 1, wherein the wherein the product to be covered is selected from one or more of at least one acidic dairy product, at least one fermented dairy product, at least one foam, at least one cream, at least one product containing fruit, at least one product containing cereal, at least one fermented product containing cereal, at least one product containing egg and at least one product containing soya.

12. The process of claim 1, wherein the metering of the food matter making up the at least one upper layer is performed using a metering piston which releases the food matter by gravity discharge through the orifices.

13. The process of claim 1, wherein the process further comprises providing a container for preparing and holding the at least one lower layer and the final product and a centrifugal force is applied to the container by the rotation of the container at about 1 to 5 revolutions/sec.

14. The process of claim 13, wherein the rotary mechanical flow regulator comprises a rotating flap vale having a flat surface which when rotated releases uniform doses of food matter from the orifices of the plate.

15. A foodstuff multi-layer product prepared by the process of claim 1.

16. The product according to claim 15, wherein the product includes one or more lower layers and one or more upper layers with alternating layers when multiple upper layers and multiple lower layers are present, and with the at least one upper layer exhibiting a uniform distribution.

17. A device for preparing a multi-layer food product, comprising:
a metering piston for metering of the food matter making up the at least one upper layer, wherein the metering piston releases the food matter by gravity discharge;
a support for preparing and holding the at least one lower layer and the final product; and
a rotary mechanical flow regulator to distribute the food matter making up the at least one upper layer onto a surface of the at least one lower layer provided on the support.

18. The device of claim 17, wherein the support is a container and further comprising a plate having a plurality of orifices for distribution of the upper layer of the food matter, and a driver to simultaneously subject the container to rotation to apply a centrifugal force to the food matter of the at least one upper layer to form the final product.

19. The device of claim 18, wherein the rotary mechanical flow regulator comprises a rotating flap vale having a flat surface which when rotated releases uniform doses of food matter from the orifices of the plate.
